(19) United States
(12) Patent Application Publication
(10) Pub. No.: US 2007/0188009 A1
(43) Pub. Date: Aug. 16, 2007

(54) Dump trailer

(76) Inventors: Kevin J. Pierce, Grand Forks, ND (US); Michael J. Pierce, Grand Forks, ND (US); Randy Dufault, East Grand Forks, MN (US)

Correspondence Address: ROBERT E. KLEVE, 1103-24TH AVE S., GRAND FORKS, ND, 58201, US

(21) Appl. No.: 10/853,910

(22) Filed: May 26, 2004

(51) Int. Cl. B60P 1/00

(52) U.S. Cl. 298/23 R

(57) ABSTRACT

The invention comprises a dump trailer having a mobile frame for towing behind a powered vehicle. A dump box is pivotally mounted at its rearward end to the mobile frame. The box has a pair of sides and a front wall with a gate pivotally mounted at its upper end to the rear portions of the side wall to pivot outward await from the side walls when the box is tilted upward on the mobile frame about its rear pivotal mounting. Latch means latching the gate to the side walls, with means automatically unlatching the gate from the side walls when the box moves from parallel position upon the mobile frame to an upward tilted position relative to the mobile frame. Supporting wheels are mounted centrally beneath the mobile frame

This invention relates to dump trailers and the like.

It is an object of the invention to provide a novel dump box trailer having a four wheels aligned in a generally single common axis laterally and centrally beneath the box of the dump trailer with said wheels having a walking beam axles.

It is another object of the invention to provide a novel dump trailer which is towable behind a powered vehicle having a hydraulically powered tilted box powered by the powered vehicle with a rear gate to the box which opens automatically when the box is tilted for emptying the box while tilted.

It is a further object of the invention to provide a novel towable trailer having four wheels aligned in a common axis with the axis laterally and centrally of the length of the trailer and with the box having hydraulic piston and cylinder powered by the towing power vehicle to tilt the box to empty the box.

Further objects and advantages of the invention will become apparent as the description proceeds and when taken in conjunction with the accompanying drawings wherein:

### BRIEF DESCRIPTION OF THE DRAWINGS

FIG. 1 is a side elevational view of the towable dump box trailer having hydraulic powered tilt mechanism.

FIG. 2 is an enlarged fragmentary right side elevational view of the towable dump box trailer lever mechanism, with the box parallel to the trailer frame.

FIG. 3 is a similar right side enlarged side elevational view of the lever mechanism for opening the rear gate of the dump box of the trailer, with the trailer tilted and the gate open.

FIG. 4 is an enlarged left side view of the lever mechanism of the trailer with trailer tilted and the lever mechanism opening the gate.

FIG. 5 is a perspective view of the trailer device with the box tilted upward.

FIG. 6 is a rear view of the dump box trailer device illustrating the latching mechanism on both sides of the gate of the box and illustrating the walking axle construction of the trailer.

FIG. 7 is an enlarged fragmentary rear view of the rear of the trailer and illustrating the latching mechanism on both sides of the trailer.

FIG. 8 is a front view of the dump trailer apparatus.

### BRIEF DESCRIPTION OF THE PREFERRED EMBODIMENT

Briefly stated, the invention comprises a dump box trailer having hitch means for attachment to a power vehicle for towing by the vehicle. The trailer has a dump box and frame with the dump box pivotally mounted to the rear of the frame for pivoting rearward and tilting upward about the pivotal axis for with a gate at the rear of the clump box which automatically opens upon tilting the box for emptying the box while tilted. The trailer has a hydraulic piston and cylinder connected between the trailer frame and the tiltable dump box for powering the tilting action of the dump box on the trailer frame with hydraulic connecting means connecting the cylinder to hydraulic pump means on the powered vehicle for the vehicle to power the hydraulic cylinder on the trailer frame.

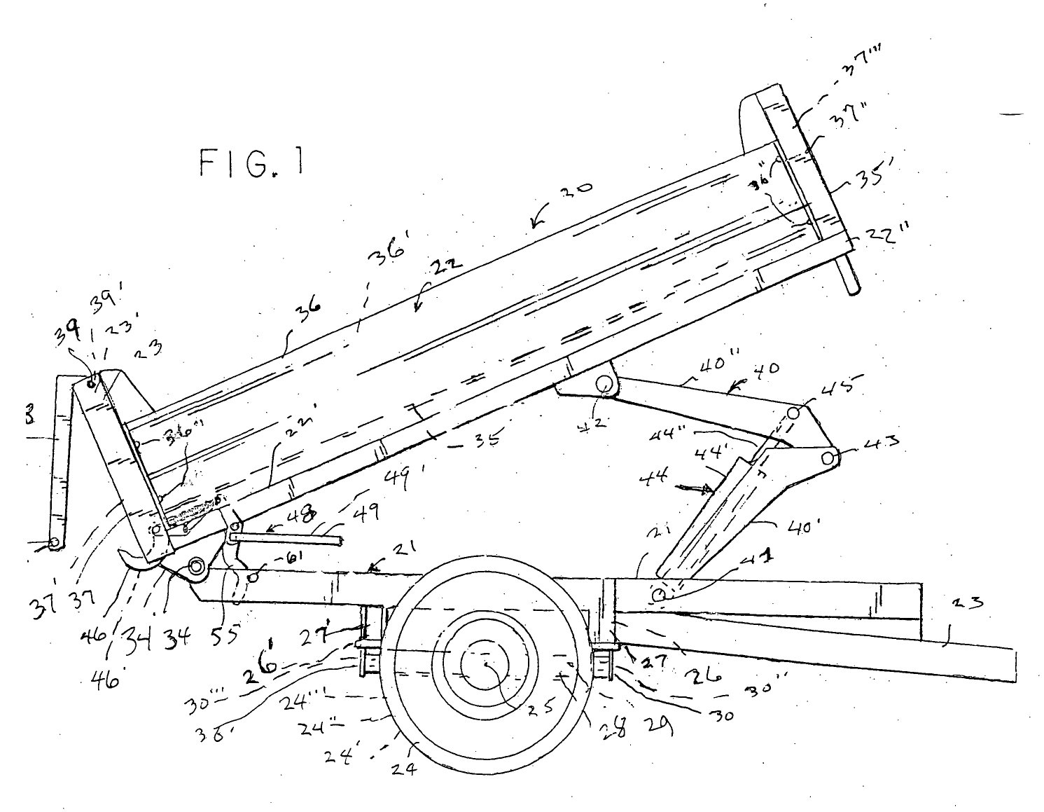

Referring more particularly to the drawings, in FIG. 1, the dump box trailer invention 20 is illustrated having a main frame 21 and al dump box 22 have a box frame or floor 22′ is positioned on top of the main frame. The main frame has a towing hitch 23 mounted to the forward end of the frame. A set of four wheels 24,24′,24″, and 24′″ are rotatably mounted beneath the trailer. All four wheels are aligned along generally on a common axis 25 extending laterally across the trailer centrally of the length of the trailer.

A pair of vertical posts 26 and 26′ extend downward from left side of the main frame 21 and are fixed thereto. A similar pair of front and rear posts 27 and 27′ extend downward from the right side of the frame 21 and are fixed thereto, A pair of tilting beams 28 and 29 are pivotally mounted at their front and rear ends 30, 30′, 30″ and 30′″, respectively, to the lower ends of the front and rear posts 26 and 26′ and 27 and 27′, respectively, along horizontal axes 31 and 31′ laterally of the common axis 25.

The beams 28 and 29 each have a pair of axle stems 32 and 32′ and 33 and 33′, respectively, extending laterally outward from opposite sides of the tilting beams 28 and 29 respectively along the common axis 25. The wheels 24 and 24′ are rotatably mounted to the outer ends of the axle stems 32 and 32′ of the tilting beam 28 so as to enable the wheels 24 and 24′ to tilt or pivot up or down about the horizontal axis 31 of beam 28 to depart from their alignment with the axis 25. Similarly, wheels 24′ and 24′″ are rotatably mounted to the outer ends axles stems 33 and 33′ of the tilting beam 29 so as to enable wheels 24″ and 24′″ to tilt or pivot up or down about the horizontal axis 31′ of beam 29 to depart from their alignment with the axis 25.

This enables one set of two wheels on one tilting beam to tilt and follow the terrain largely and tilt independently of the other set of two wheels on the other beam as it tilts to follow the terrain so as to enable each set to correspond and follow the terrain level as to the particular terrain beneath that set of wheels and tilt independently of the other set of two wheels.

The dump box 22 at its rear bottom end of the trailer frame 22′ is pivotally mounted to the rear of the main frame 21 at pivot mountings 34 and 34′. The dump box is rectangular and has bottom member or floor 35, a front wall 35′, and a pair of detachable side walls 36 and 36′. At the rear of the side walls are a pair of rear upright corner posts 37 and 37′ are fixed to the floor or bottom member 35 of the box at the rear of the box and extend upward. At the front are a similar pair of corner posts 37″ and 37′″ which are also fixed to the floor 35 of the box and extend upward. A gate member or pivoting rear wall member 38 is pivotally mounted to the upper ends of the rear corner posts 37 and 37′ by removable pivot pins 39 and 39′ to enable the gate to pivot open away from the posts and close beside the posts to form a rear closure for the box. At the front of the box is a front wall 35′ fixed across and between the front corner posts 37″ and 37′″. The side walls 36 and 36′ are removably mounted to the corner posts by bolts 36″. The end gate 38 is also detachable or removable by removing the pins 39 and 39′.

A scissor lift arm 40 is positioned beneath the center of the box and has one arm segment 40′ pivotally mounted at its one end to the trailer frame 21 at pivot 41 and another arm segment 40″ pivotally mounted at its one end to the underside of the truck box at pivot 42, with the other ends of the arm segments pivotally connected together at pivot 43. A hydraulic piston and cylinder 44 has its cylinder 44′ pivotally mounted to the frame 21 at pivot 41 and its piston 44″ pivotally mounted to arm segment 40″ of the scissor lift at pivot 45. Hydraulic lines (not shown) are connected to the cylinder 44′ at one end and extend forward for mounting to the hydraulic pump on the powering vehicle for powering the hydraulic piston and cylinder 44, whereby powering the hydraulic cylinder 44′ to telescope its piston 44″ will raise the forward end 22″ of the box 22 causing its to tilt the box upward rearward at an angle about its rear pivotal mounting 34 and 34′ on horizontal axis for emptying the box as shown in FIG. 1. A pair of hooks 46 and 46′, in lateral alignment to one another, are pivotally mounted to each of the rear corner posts 37 and 37′, respectively, of the truck box 22 at loots 47 at the rear of the dump box. The hooks 46 and 46′ are pivotally mounted to pivot upward to engage pins 54 and 54′ on gate 38 to lock the gate 38 at the rear of the box closed against the corner posts 37 and 37′ of the box, as shown in FIG. 2.

Mounted beneath the bottom of the box at the rear of the dump box is a locking mechanism 48 for locking the gate 38 to the box. The mechanism has a horizontal control rod 48′ which extends laterally across the box. The rod 48′ extends laterally across the rear of the truck box along the bottom of the box. A pair of handles 49 and 49′ are fixed to opposite ends of the rod 48′ on each side of the box and extend forward from the rod on each side of the box.

The locking mechanism 48, on each side of the box, is provided for locking the hooks 46 and 46′ up around the pins 54 and 54′ on the gate. The locking mechanism also has a pair of lever members 50 and 50′ which are fixed to the lateral control rod 48′ and extend vertically upward on opposite sides of the box. The intermediate lower ends of the lever members 50 and 50′ are fixed to pins 51 and 51′ on opposite sides of the box to pivot with the pins about the axes of the pins relative to the frame, respectively. Each lever member 50 and 50′ at its upper end has an upper first link member 52 and 52′ pivotally connected to the upper ends of the lever members 50 and 50′, respectively, at pivots 50″ and that extend rearward; and the first link members, in turn, are pivotally mounted at their rearward ends to second link members 53 and 53′, respectively, at pivots 53″.

These second link members 53 and 53′ are in turn are fixed at their ends to the hooks 46 and 46′, respectively, in corner posts 37 and 37′, respectively, at pivots 47 and 47′, respectively, to pivot with the hooks about pivots 47 and 47′ in corner posts 37 and 37′, respectively.

A pair of springs 56 and 56′ have their one ends 57 and 57′ hooked to the box frame and their other ends hooked to the tops of lever members 60 and 60′, respectively, at pivots 60″ to urge the lever members and link members rearward, when viewed from FIG. 2 and have sufficient spring strength to keep the hooks pivoted upward and locked about the pins on the gate.

The lever member 60 is also fixed to a pin 51 at its lower end, which pin is pivotally mounted beneath the longitudinal beam 90 of the box and extends across the beam and the pin is fixed on the other side to the lever member 50 so that lever member 60 pivots on pin 51 with lever member 50 on the other side of the beam so that the two pivot together, and which under spring urging in turn pivot the hook 46 upward to its locked position. Similarly, lever member 60′ is fixed to pin 51′ at its lower end, which pin pivotally mounted beneath the beam 90′ of the box and extends across the beam and the pin is fixed on the other side of the beam to lever member 50′, so that lever member 60′ pivots on pin 51′ with the lever member 50 so that the two pivot together to in turn, under spring urging, pivot the hook 46′ clockwise upward when viewed from FIG. 2 to its locked position.

The locking mechanism 48 also has a cam member 55 fixed to the bottom of lever member 60. The cam member 55 and its action automatically causes the unlocking of the gate by lowering the hooks 46 and 46′ that hare been engaging the gate pins, as the cam rises with the box.

The lever member 60 extends downward from rod 48′ to form cam member 55 and is fixed to the rod 48. The cam member 55 extends downward from the rod 48′ and has a front cam surface 55′ to engage the rear of a pin 61, and pin 61 is fixed to the trailer frame 21.

The gate locking mechanism is constructed to unlock or unhook the gate from the corner posts of the box manually or automatically.

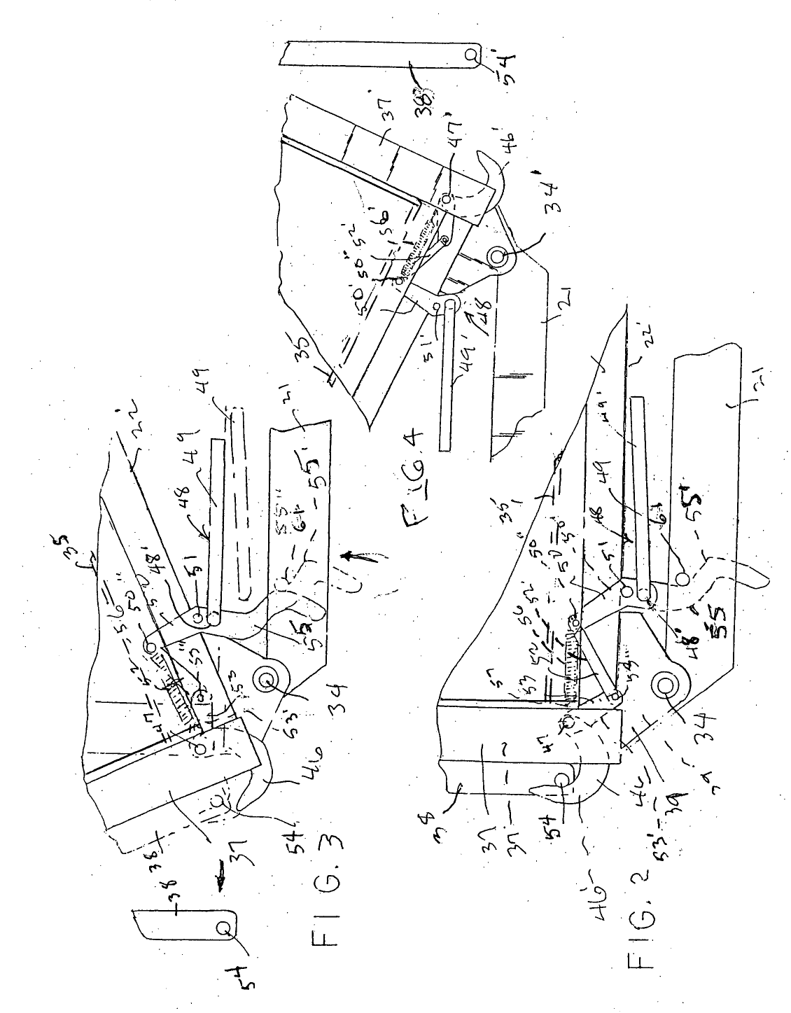

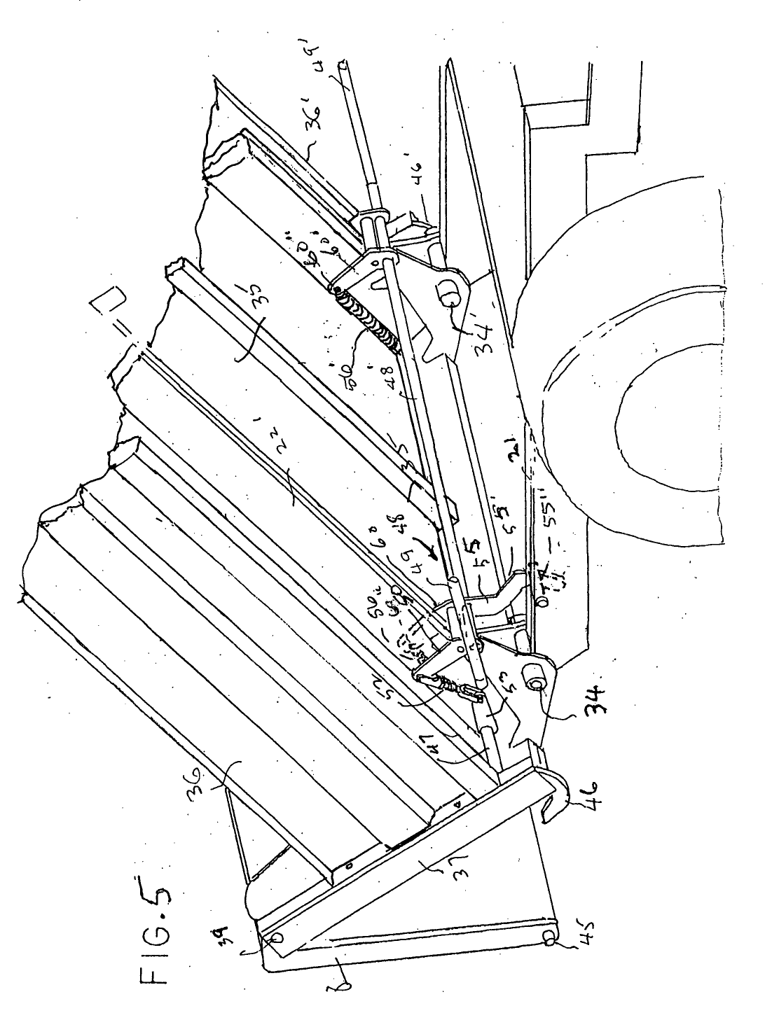

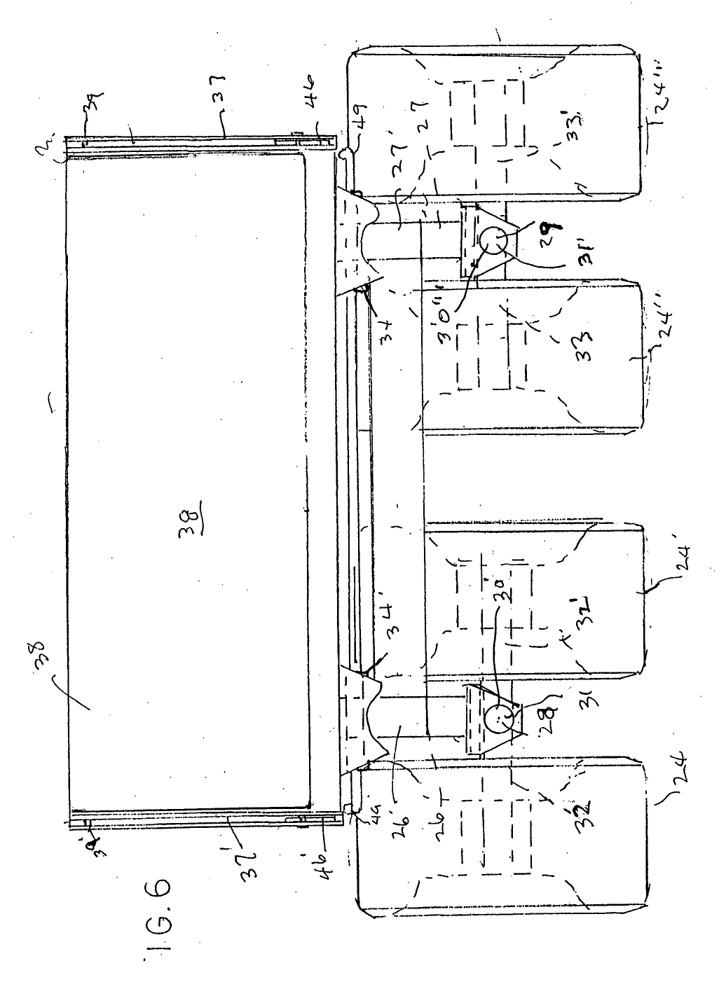

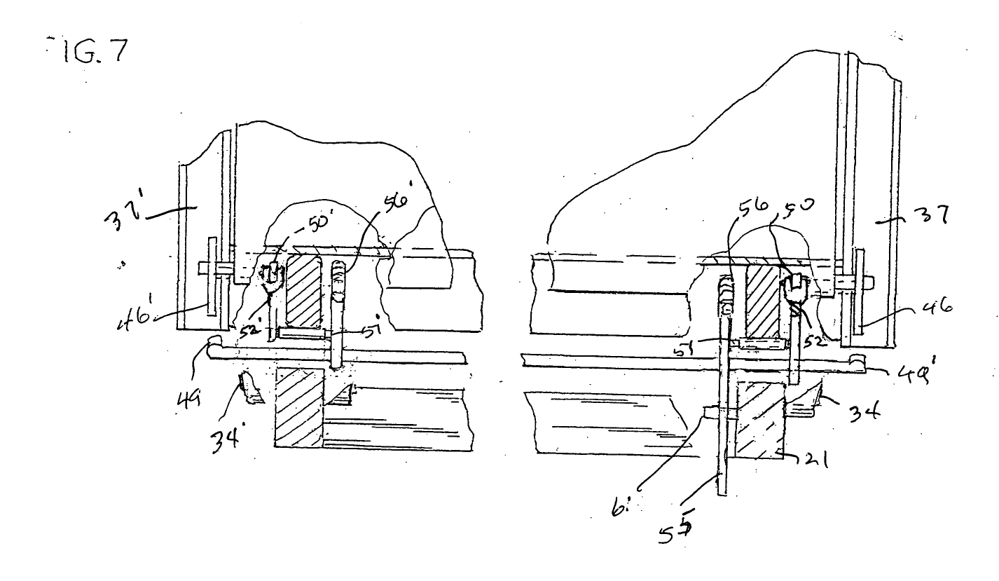

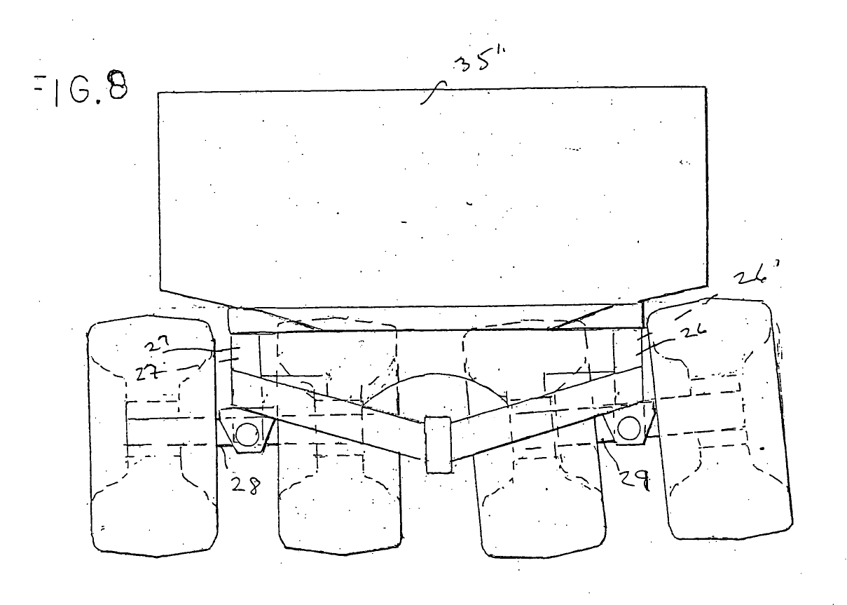

To unlock the gate manually, an operator will rotate one of the handles 49 or 49′ manually clockwise downward, when viewed from FIG. 2, as the operator will manually, overcome the action of the springs keeping the hooks locked about the pins on the gate. His rotating the handle 49 downward clockwise as viewed from FIG. 2 causes the rod 48′ and level members 50 and 50′ to rotate about the pivotal mounting of the lever members on pivots 51 and 51′ clockwise which draws the link members 52 and 52′ and 53 and 53′ forward on opposite sides of the box. The movement of the first and second link members forward acts to pivot the hooks counterclockwise on their pivots thereby lowering the hook ends of the hooks below the pins 54 and 54′ on the gate to their position as shown in FIG. 3, thereby releasing the gate so that it may swing freely open and away from the box at their upper pivots 39 and 39′ of the box.

The tilting of the truck box rearward and upward about its pivotal mounting causes the locking mechanism to automatically unlock or unhook the gate from the corner posts of the box by automatically lowering the hooks relative to the gate.

If the hydraulic lift aim is hydraulically actuated to tilt the trailer box upward from its horizontal position shown in FIG. 2 to its upward tilted position shown in FIG. 1; the locking mechanism 48 also automatically lowers the hooks 46 and 46′ from the pins 54 and 54′ on opposite sides of the gate, releasing and freeing the gate 38 as the dump box is pivoted upward to an angle relative to the dump trailer frame. This automatic unlocking action is provided to prevent the trailer from accidentally causing the box to tip over rearward which might occur by the shifting of a load rearward on the box if the box were tilted upward without the rear gate 38 being opened.

The locking mechanism 48 and its cam member 55, being mounted to the box, rises with the box when the box is tilted upward by the hydraulic mechanism relative to the main frame.

Raising the dump box, relative to the main frame, about its pivots from its lower horizontal position as shown in FIG. 2 to its upward angular position shown in FIGS. 1, 3 and 4 causes the cam 55 to rise with the box upward while sliding upward along the pin 61 on the main frame being continuously urged against the pin on the frame. The upward movement of the cam 55 causes the pin 61 to engage the cam surface 55′ of the lower portion, which acts to pivot the cam clockwise relative to dump box frame causing the rod 48′ to rotate clockwise which in turn rotates the upper lever members on the rod 48′ clockwise. This, in turn, draws the link members left to light when Viewed from FIG. 2 relative to the box, which in turn pivots the hooks 46 and 46′ counter clockwise lowering the rear ends of the hooks below the pins on the gate and thereby automatically freeing the gate from the hooks on the corner posts, so that the gate is free to pivot clockwise to open the rear of the dump box.

The cam 55 is configured to engage the pin 61 on the main frame and move along the pin if the box is tilted upward relative to the main frame with the contour of the cam on the pin causing the cam 55 to pivot counter clockwise on the box and draw the link members on the box forward and thereby automatically pivoting the hooks lower and releasing the pins on the gate to free the gate on the box so that the gate may pivot open freely clockwise when viewed from FIGS. 1-3, inclusive; as pulling or drawing the link members 52 and 52′, respectively, left to right pivots the link members 53 and 53′, respectively, of the hooks 46 and 46′, respectively, counterclockwise thereby pivoting the hooks 46 and 46′ downward to lower the ends of the hooks to their positions as shown in FIG. 1, 3, and 4, for example and releasing pins 54 and 54′ on each side of the gate to release the, bottom of the gate so as to be free to pivot open as shown in FIG. 3.

The pin 61 is fixed to one side beam 62 of the trailer frame 21, and causing the cam surface on the lower portion 55′ to engage continuously against the pin and react buy the change in the shape of the cam surface.

Consequently when the box is down horizontal and parallel to trailer frame, the springs will have urged the lower cam surface of the lower leg portion against the pins, and the change in the shape of the upper portion 57″ of the cam surface, causes the linkage to pivot the hooks clockwise upward on the posts rearward beside the pins the gate to lock the gate parallel to the posts as shown in FIG. 2.

Consequently, any time the box is tilted upward at an angle, the gate is automatically and immediately free, by the cam action, to swing open under gravity action.

The device is designed to automatically unlatch the gate if the box is tilted backward, because if the box were accidently tilted when there was a load in the box and the gate were not opened, it would create an imbalance on the trailer because of the wheels all being along a same single central horizontal axis which is along an axis centrally of the length of the box. Consequently, if the gate were not automatically opened the load would shift to the rear and would create too much load on the rear end of the trailer about the centrally located wheels, causing it to try to tilt rearwardly about the central wheels and tend to tilt the front of the trailer upward.

Thus, it will be seen that a novel dump box trailer has been provided with a power operated hydraulic piston and cylinder to tilt the box on its frame, with only one main wheel supporting apparatus comprising a dual pair of wheels with each pair mounted to a separate axle and with each axle pivotally mounted to the frame and with both pairs of wheels mounted generally along the same generally axis which axis is laterally across the length of the trailer.

It will be obvious that various changes and departures maybe made to the invention without departing from the spirit and scope thereof, and accordingly, it is not intended that the invention be limited to that specifically described in the specification or as illustrated in the drawings, but only as set forth in the appended claims wherein:

What is claimed is:

1. A dump trailer apparatus comprising a frame, a clump box having its rearward end pivotally mounted to the frame, said dump box having a pivotally mounted gate at it rearward end which may be opened for emptying the box, said frame having hydraulic piston and cylinder means connected pivotally at each end between the frame and box and hydraulically actuatable to pivot the box rearward and upward about its rearward pivotal connection to the frame to allow the gate of the box to open to empty the box of its contents, automatic unlatching means to automatically unlatch the gate when the box is pivoted rearward and upward.

2. A dump trailer apparatus comprising a mobile frame, a dump box having its rearward end pivotally mounted to the frame, said box having opposing side walls and a front wall with a gate pivotally mounted at its upper end to the rear of the box to pivot outward away from the side walls of the box when the box is pivoted upward and rearward, hydraulic means to power the pivotal upward movement of the box, means to latch the gate closed against the side walls of the box, cam means on the dump box automatically engaging means on the mobile frame automatically unlatching the gate from its closed position upon pivoting the box upward for unloading the materials in the box from the box to enable the gate to pivot open outward away, from the box.

3. A dump trailer apparatus according to claim 2 wherein said trailer frame has a dual pair of wheels aligned in a common lateral axis centrally and laterally across the trailer mobile frame, each of said pair of wheels being rotatably mounted on a pair of axles with each pair of axles independently mounted on a tilt bar beneath the trailer mobile frame whereby one of said pair of wheels may tilt relative to the other of said pair of wheels to allow each pair of wheels to tilt at an angle relative to the lateral pair of wheels to allow each pair to independently adjust to differences in the lateral surface of the terrain beneath the wheels as the wheels travel along the terrain.

4. A dump trailer apparatus comprising a mobile frame, a dump box having its rearward end pivotally mounted to the mobile frame, hydraulic means to power pivoting box upward from a horizontal parallel position on the mobile frame to an upward angle, said box having opposing side walls and a front wall with a gate serving as a rear wall with its upper end pivotally mounted to rear portions of the side walls to pivot outward away from the side walls when the box is pivoted upward and rearward about its rear pivotal mounting to the mobile frame, hook means to latch the gate closed against the side wails of the box, cam means engagable by the tilting of the truck box upward relative to the mobile frame by said hydraulic means to automatically unlatch the hook means holding the gate closed against the side walls of the box, a dual pair of wheels mounted centrally across the bottom of the dump box in a common lateral axis with each pair pivotally mounted on a separate dual axle with each axle serving two wheels in each pair.
